(19) United States
(12) Patent Application Publication
(10) Pub. No.: US 2010/0018140 A1
(43) Pub. Date: Jan. 28, 2010

(54) PLASTIC PROFILE FOR WINDOW, DOOR AND FACADE ELEMENTS

(75) Inventors: Erwin Brunnhofer, Fuldabruck (DE); Thomas Muster, Kassel (DE); Ferdinand Bebber, Ahnatal (DE)

Correspondence Address: J-TEK LAW PLLC, 601 Pennsylvania Avenue, NW, Suite 900, South Building, Washington, DC, 20004, US

(73) Assignee: Technoform Caprano und Brunnhofer GmbH & Co. KG, Fuldabrück (DE)

(21) Appl. No.: 12/520,311

(22) PCT Filed: Dec. 14, 2007
(86) PCT No.: PCT/EP07/11025

§ 371 Date: Aug. 3, 2009

(30) Foreign Application Priority Data
Dec. 22, 2006 (DE) 10 2006 061 035.0

(51) Int. Cl. E06B 3/988; E04C 2/38

(52) U.S. Cl. 52/204.71; 52/717.05

(57) ABSTRACT

A plastic profile for window, door and facade elements includes a plastic profile body, which extends in a longitudinal direction (z), and at least one outer side, which is located outside in a transverse direction (x) perpendicular to the longitudinal direction (z) as viewed in a cross-section (x-y) perpendicular to the longitudinal direction (z). The outer side includes two roll-in protrusions configured such that a reinforcement element is connectable with the plastic profile body by a rolled-in connection. The reinforcement element has at least one of a hollow profile, a partially-open profile and a receptacle portion configured to accommodate a corner connector, wherein at least one of the hollow profile, the partially-open profile and the receptacle portion is disposed between the roll-in protrusions in the rolled-in state.

The present invention relates to a plastic profile for window-, door- and facade-elements.

Window systems generally are comprised of a wing profile and a frame profile, wherein the wing is glazed and the frame is connected with the building-shell (brickwork). These profiles are, for example, made of wood, steel, aluminum, plastic or combinations of these materials. The diversity of the competing materials is partly based on tradition; however, the factors thermal properties, wind-resistance, maintenance and maintenance costs, aesthetic impression and price are also important for the selection of the material.

Extruded plastic hollow profiles for windows and doors are known in the prior art (e.g., DE 33 19 144A1), in which the hollow profile part has a plurality of hollow chambers that extend along the hollow profile member. Such hollow profile parts are usually made of rigid PVC. One or more of the internal chambers can be filled with foamed plastic (see also EP 1 154 115 B1). The corner connection of window frames made of such hollow profiles is manufactured by welding or by the use of corner connectors, which are adhered in place.

Window systems (e.g. under the designation Corona CT 70 Plus) having foam-free plastic hollow profiles with a plurality of hollow chambers and conventional steel reinforcement are offered by the window manufacturer Schüco of Bielefeld, Germany, wherein steel-reinforced profiles are inserted into hollow chambers. The steel-reinforced profiles are also used for anchoring of fittings. In these window-systems, the attachment of decorative external covers made of aluminum is possible.

Profile members made of plastic-foam for window elements are known from DE 201 05 876 U1, DE 32 42 909 A1 and WO 97/22779 A1, respectively, in which insulating frames (DE 201 05 876 U1) or profile parts made of metal (DE 32 42 909 A1) or also profile parts made of wood or plastics (WO 97/22779 A1) are connected with the core made of plastic foam in different ways. In the PU-foam core known from DE 201 05 876 U1, separate core-profiles are provided in the PU-profile.

A plastic profile component for window and door elements is known from EP 1 705 334 A2, wherein metal profile parts are adhered to, or also rolled into, both outer sides of the plastic profile part, which outer sides form the interior and exterior sides of the window and door element.

Furthermore, aluminum window, door and facade elements, which are comprised of weather-side and interior-side aluminum profiles made of aluminum-plastic-composite profiles, are known, which aluminum profiles are friction-fit/form-fit connected to plastic profiles. In the manufacturing of the components, the profiles are assembled into frames, wherein the corners are mechanically connected via inserted corner connectors. Moreover, composite window, door and facade elements, which are comprised of weather-side and interior-side profiles made of composite profiles using freely-selectable materials, are known, which are friction-fit/form-fit connected to plastic profiles (EP 1 555 376 A1). DE 200 16 611 U1 discloses a reinforced plastic window profile for windows, etc., wherein a U-shaped groove for accommodating fittings, etc. is provided; a reinforcement profile is affixed in the groove.

It is an object of the invention to provide an improved plastic profile for window, door and facade elements and a reinforced plastic profile having such a plastic profile for window, door and facade elements.

This object is achieved by a plastic profile according to claim 1, 2 or 5, or a reinforced plastic profile according to claim 13, or a window, door, or facade element according to claim 20, respectively.

Further developments of the invention are provided in the dependent claims.

A profile system for windows, doors and facades is enabled by the invention, wherein hollow profiles made of plastic and having rolled-in reinforcements are utilized, which reinforcements are installed in a positionally-precise and longitudinally-fixed manner and which make possible an insulating zone that is a comparatively large proportion of the total constructional depth.

One embodiment of an inventive profile system for windows, doors and facades comprises plastic profiles, preferably made of plastic hollow profiles, and outwardly-disposed reinforcement profiles, preferably made of aluminum, which have an accommodation chamber for corner connection elements precisely positioned relative to the outer surface and which are connected in a longitudinally-fixed manner with the plastic hollow-profile using a roll-in process.

The plastic profile forms an insulating zone and the proportion of the insulating zone relative to the total constructional depth from the interior side to the weather side preferably is 80% or more, even more preferably 90% or more, or even more preferably, 95% or more.

The profiles can be connected, in a manner analogous to aluminum windows, via corner connectors to components such as window, door and facade elements.

A manufacturing method is used for the manufacture of the plastic profiles made of, e.g., rigid-PVC, PA, PET, PBT, PA/PPE, ASA (reinforced or not reinforced) or others, which calibrates the external contour as well as the internal contour in a positionally-precise manner.

A precision can be ensured by the positionally-precise calibration, with which inserted and affixed reinforcements are positioned relative to the external contour with the required low tolerances.

The invention offers several advantages for designing the properties of window, doors and facade elements, in which the reinforced plastic profile is utilized.

a) Thermal Properties

The thermal rating can be determined by the increased proportion of the plastic hollow profiles in the constructional depth and by the configuration, size and partitioning of the interior hollow spaces, as well as the foam filling thereof.

b) Mechanical Properties

The mechanical properties, such as torsional resistance, etc., can be determined by the constructional depth (i.e. the distance between the weather-side and the interior-side reinforcements) and by the configuration, size and cross-sectional area of the reinforcements.

c) Cross-Section

In the cross-section of the profiles, undercuts and geometries of arbitrary complexity for accommodating fitting and locking elements, seals, etc., are made possible by the use of the plastic hollow profiles.

d) Surface and Coloration

The surface and coloration may also be varied in many ways for the differing designs of the weather side and the interior side by the choice and pigmentation of the plastics and/or through the use of decorative elements.

The external contour of the hollow profile is determined by the required functions, such as e.g.:

a) sealing receptacle, sealing stop, fitting receptacle in the closing plane;

b) block surfaces, functional grooves for the glass guide rail, glass seal receptacle, and drainage for the glazing,

c) grooves, window sill stop, receptacle for sealing films, etc., for the building shell (brickwork), and

d) glossy, colored and weather-proof surfaces of the hollow profile and/or latches for the attachment of decorative profiles made of plastic, wood, aluminum or stainless steel (extruded or rolled) for the external and interior sides.

The reinforcement preferably comprises extruded aluminum hollow profiles having an interior contour for the accommodation of corner connectors (as is usual for aluminum windows) and an external contour having positioning surfaces for the precise fixing of the position in the plastic hollow profile.

The reinforcements can have additional functions such as are required for the threaded connection of T-joints or fittings.

The plastic hollow profiles are preferably comprised of reinforced materials, e.g. PA 66 GF, and include functional elements on the external contour, e.g. for the accommodation of fitting and locking elements, seals, glass guide rails, accommodation of decorative covers and the like.

The plastic hollow-profiles for windows, doors and facades achieve a satisfactory static bearing capacity due to the reinforcement profiles, which are connected in a longitudinally-fixed manner and are preferably formed of aluminum. The reinforcement profiles preferably include a portion that is suitable for the accommodation of corner connectors. Preferably, functional portions for the accommodation of fitting and locking elements, seals, glass guide rails can be integrated into the plastic hollow profile. The reinforcement profiles preferably can be covered with decorative covers. The plastic hollow profiles fulfill application-specific mechanical requirements by selecting a suitable plastic material, e.g. PA 66 GF.

The reinforcement-profiles can be prepared in a suitable manner for the longitudinally-fixed connection with the plastic profile, e.g. by knurling.

Further features and utilities will be derived from the description of embodiments with the assistance of the figures. In the figures:

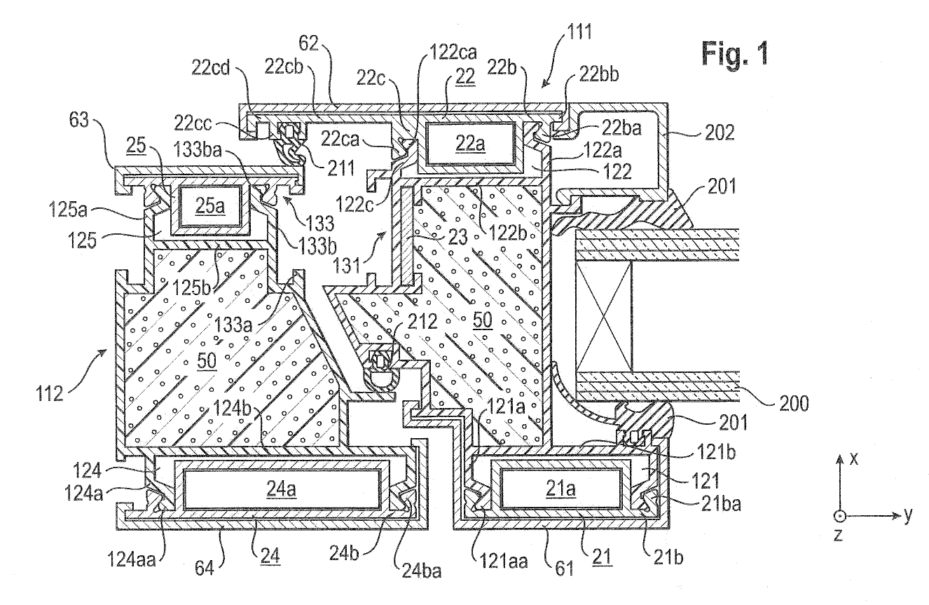

FIG. 1 shows a cross-sectional view perpendicular to the longitudinal direction of a reinforced plastic profile according to a first embodiment of the invention;

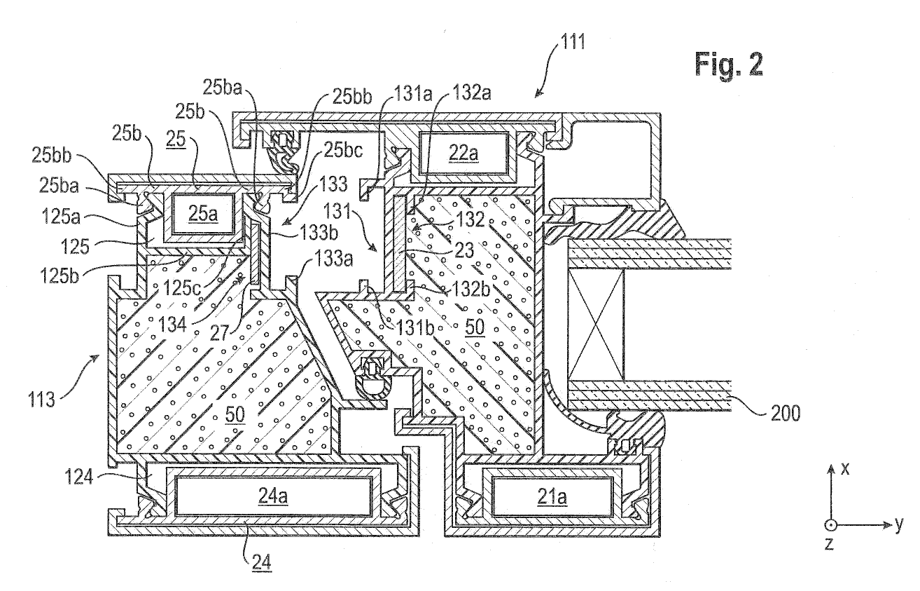

FIG. 2 shows a cross-sectional view perpendicular to the longitudinal direction of a plastic profile according to a second embodiment of the invention;

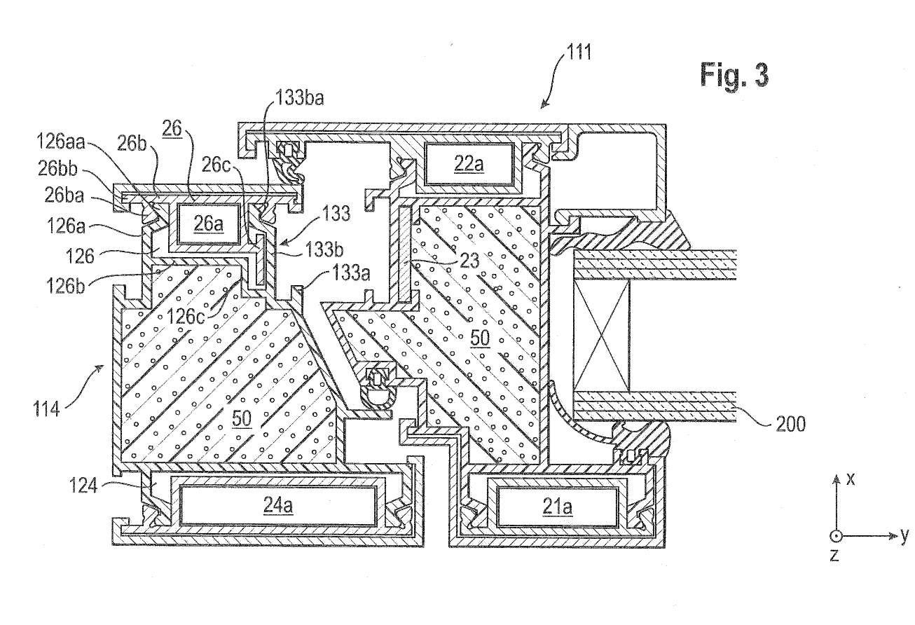

FIG. 3 shows a cross-sectional view perpendicular to the longitudinal direction of a plastic profile according to a third embodiment of the invention;

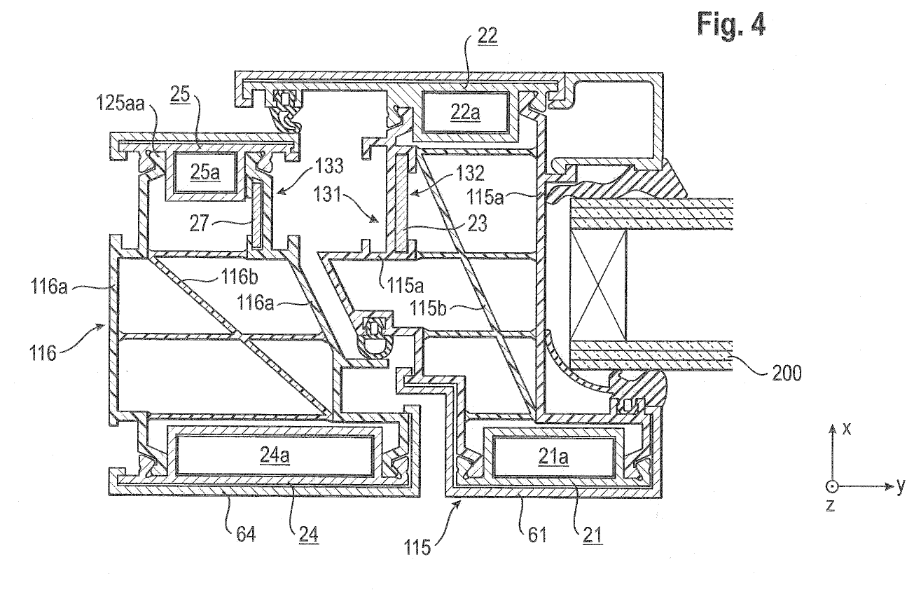

FIG. 4 shows a cross-sectional view perpendicular to the longitudinal direction of a reinforced plastic profile according to a fourth embodiment of the invention;

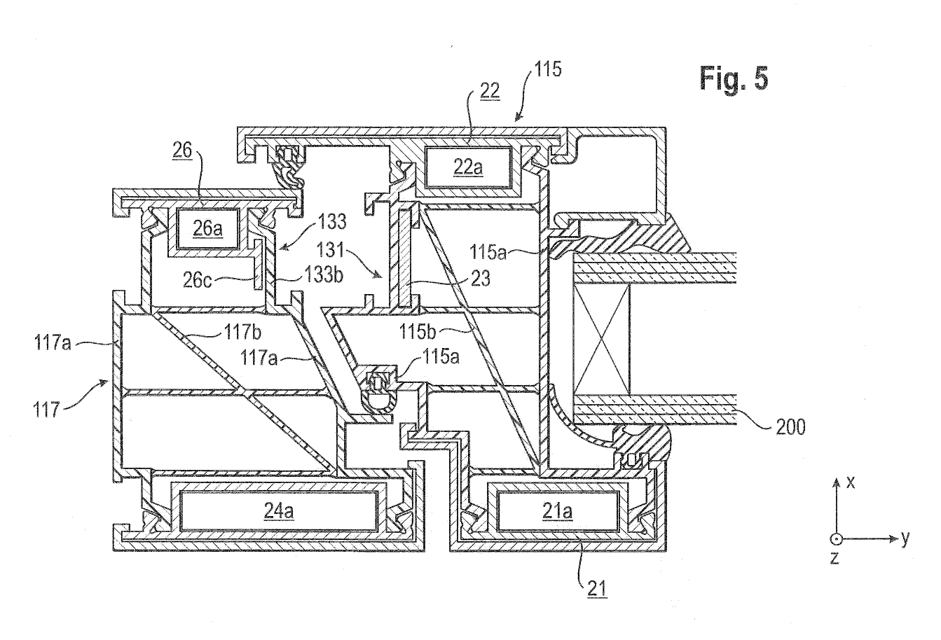

FIG. 5 shows a cross-sectional view perpendicular to the longitudinal direction of a reinforced plastic profile according to a fifth embodiment of the invention; and

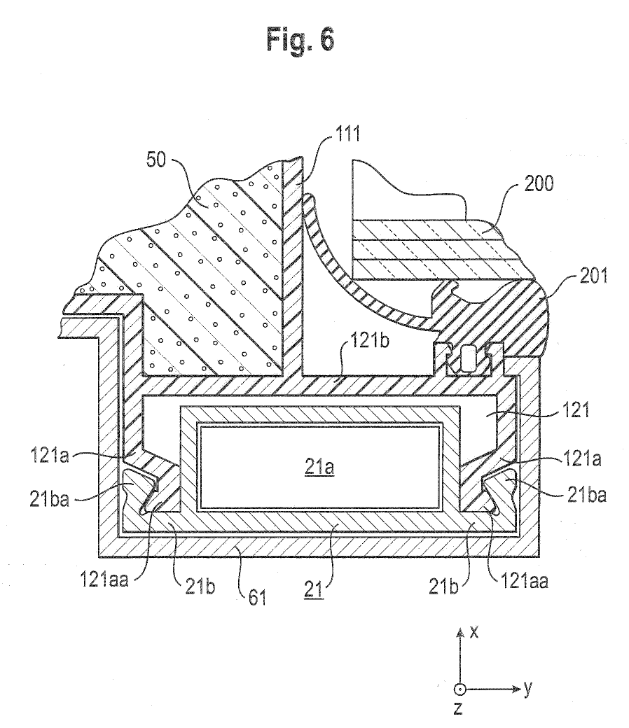

FIG. 6 shows an enlarged view of a portion of the first embodiment from FIG. 1.

A first embodiment of the invention will be described with reference to FIG. 1 and FIG. 6. FIG. 1 shows profile parts as components of a frame profile and of a window wing profile in the cross-section (x-y plane) perpendicular to the longitudinal direction (z) of the respective profile members.

On the right-hand side of FIG. 1, a plastic hollow profile 111 is shown in the cross-section perpendicular to its longitudinal direction, which profile 111 forms a part of a window wing. A double-glass window pane 200 can be retained at/in the frame of the window wing in a known manner via sealing/attachment elements 201, which may also formed in a different shape, and a glass guide rail 202. The top side in FIG. 1 is the interior side and the bottom side in FIG. 1 is the weather side of the profile members.

The plastic hollow profile 111, which forms a part of a window wing, extends in a transverse direction x perpendicular to the longitudinal direction z and perpendicular to a width direction y, which in turn is perpendicular to the longitudinal direction z, from the weather side (bottom side in FIG. 1) to the interior side (top side in FIG. 1). An aluminum hollow profile 21 is affixed to the plastic hollow profile 111 on an external side (weather side) in a manner described below. On the opposite side in transverse direction x, i.e. on the interior side (top side in FIG. 1), an aluminum hollow profile 22 is affixed in a similar manner. A hollow chamber is located between the two outer sides, which in the first embodiment is foam-filled with a foam 50 having a low density. In the cross-section (x-y) perpendicular to its longitudinal direction z, the plastic hollow profile has a complex geometry with undercuts, protrusions and the like for the accommodation of fitting and locking elements (not shown), seals 201, 211, 212, reinforcement rails 23 and other elements such as the window rail 202 and/or for the mounting of decorative elements 61.

The attachment of the aluminum hollow profiles 21, 22 will now be described with reference to FIG. 6 in an exemplary manner for the aluminum hollow profile 21. As can be clearly seen in FIG. 6, the plastic hollow profile 111 includes roll-in protrusions, such as the roll-in protrusions 121a, at the respective outer side (in this case the weather side), which protrude from the plastic hollow profile 111 in the transverse direction x and thus form the farthest protruding sections/parts of the plastic hollow profile 111 on this outer side.

The aluminum profile 21 extends in the longitudinal direction z and has a hollow chamber 21a surrounded by an outer wall having a rectangular shape in cross-section. The hollow chamber may, of course, also have other cross-sectional shapes, but a rectangular cross-section, the longer side of which extends in the width direction y, is preferred. Protrusions 21b extend from the rectangular wall in width direction y; the ends of these protrusions are formed as hammers (roll-in hammers) 21ba for rolling-in and form the groove together with another part of the aluminum hollow profile (in this case, the wall of the hollow chamber).

As can be clearly seen in FIG. 6, the roll-in protrusions 121a of the plastic hollow profile 111 are formed in a suitable bent shape such that the tips, as the heads (roll-in heads) 121aa of the roll-in protrusions 121a, cooperate with the hammers 21ba of the protrusions 21b of the aluminum hollow profile 21 for the longitudinally-fixed retention of the aluminum profile, and such that the aluminum profile 21 comes into contact with the plastic hollow profile only at the heads 121aa. The plastic hollow profile is accommodated in a receptacle 121 such that it is surrounded by an air cushion and does not otherwise come into contact with the plastic hollow profile 111. This means that the length of the protrusions 121a, i.e., the extent of the protrusion relative to the wall 121b, which bounds the receptacle 121, is determined such that the depth of the aluminum profile 21 relative to the protrusions 21b is less as measured in the transverse direction x.

The above explanations for the configuration of the roll-in protrusions and of the aluminum hollow profiles apply to all embodiments.

The wall 121b is, in principle, not required for the inside boundary of the receptacle 121, as will be explained further below with reference to FIGS. 4 and 5. However, an inside boundary of the receptacle 121 is provided and preferred in the present first embodiment.

As shown in FIG. 1, the aluminum hollow profile 22 is affixed to roll-in protrusions 122a, 122c on the opposite outer side (interior side) of the plastic hollow profile 111 in a longitudinally-fixed manner by rolling-in in a similar way. Here, the roll-in protrusions 122a, 122c are not formed with the same length, which is different than the case of the weather side. However, the roll-in protrusions 122a and 122c are also the sections/parts of the plastic hollow profile 111 that project the farthest in the transverse direction x on the interior side.

The aluminum hollow profile 22 has a hollow chamber 22a, which is surrounded by a wall having a rectangular cross-section, and protrusions 22b, 22c extending in the width direction y. Unlike in the aluminum hollow profile 21, these protrusions are adapted to realize further functions. For example, the protrusion 22b includes another protrusion 22bb, in addition to the hammer 22ba for rolling-in, which protrusion 22bb serves to click-attach a decorative element 62. The protrusion 22c includes the hammer 22ca for rolling-in and an extension 22cb, on which a receptacle 22cc for the seal 211 and a protrusion 22cd for the click-attachment of the decorative element 62 are provided.

In principle, the aluminum hollow profiles 21, 22 serve as reinforcement elements that are connected to the plastic hollow profile 111 in a longitudinally-fixed manner by rolling-in. In this way, the mechanical properties of a reinforced plastic hollow profile, which is comprised of the plastic hollow profile 111 and the aluminum hollow profiles 21, 22, are achieved.

By constructing a plastic hollow profile 111 such that the roll-in protrusions 121a, 122a, 122c are the farthest protruding sections/parts of the plastic hollow-profile 111 in the transverse direction x, and by disposing the substantial part of the aluminum hollow profile substantially between the roll-in protrusions, or expressed more generally, within the plastic hollow profile, a maximum enlargement of the insulating zone formed from plastic is achieved relative to the total constructional depth in transverse direction x. Different from known composite profiles, the enlargement of the cross-section of the aluminum hollow-profile in transverse direction x is not added to the size of the insulating zone, but rather in the present case the largest part of the enlargement of the cross-section of the aluminum hollow profile in the transverse direction x is within the enlargement of the insulating zone in the transverse direction x, without reducing the enlargement of insulating zone x.

As a result thereof, the proportion of the insulating zone relative to the total constructional depth in the transverse direction x of at least 80%, in the present case (without decorative covers) of even 92% in the case of the plastic hollow profile 111 reinforced with aluminum hollow profiles 21, 22, is achieved. By appropriately modifying the protrusion 22c and extending the roll-in protrusion 122c to the length of roll-in protrusion 122a, even 96% is possible.

The decorative elements 61, 62 can, for example, be formed as aluminum covers that can be clipped onto the profile. Other materials such as stainless steel, wood, plastic, etc. can also be used for the decorative elements 61, 62. It should be considered that the use of a material for the decorative covers that conducts heat very well, especially when the decorative covers extend further in transverse direction x to the inner side of the plastic hollow profile 111, like the decorative cover 61 (in contrast to decorative cover 62), causes a deterioration of the insulating properties, which is, however, much smaller than the improvement achieved through the described connection of the aluminum hollow profiles with the plastic hollow profile. Moreover, these decorative elements can be formed very thin-walled, so that further optimizations are possible here, too.

As was already described above, the plastic hollow profile 111 has a complex geometry. The plastic hollow profile 111, for example, has an undercut recess 131 that is adapted for the accommodation of fittings and locking elements. In the subsequent description, reference to FIG. 2 is made, the plastic hollow profile 111 of which is identical with the plastic hollow profile 111 of the first embodiment. The recess 131 extends in the longitudinal direction z. In the width direction y, the outer wall of the plastic hollow profile 111 forms the back wall of the undercut recess 131. In transverse direction x, the recess 131 is bounded on the interior side by a hook-shaped protrusion 131a. In the transverse direction x, on the weather side, the outer wall of the plastic hollow profile 111 extends at a right angle from the part that forms the back wall and includes a protrusion 131b protruding towards the interior side, so that the undercut recess 131 is bounded as a whole.

Another undercut recess 132 is formed on the inner side of the back wall of the undercut recess 131. The undercut recess 132 is bounded by the same part of the outer wall of the plastic hollow profile 111 as the back wall in the width direction y. In the transverse direction x, on the weather side, the recess 132 is bounded by a hook-shaped protrusion 132b and on the interior side by the outer wall of the plastic hollow profile 111 and by a protrusion 132a protruding at a right angle from this outer wall towards the weather side.

The recess 132 forms a receptacle for a reinforcement element (reinforcement bar) 23, whose function is the secure attachment of the fitting and locking elements, which are received in the undercut recess 131 on the outer side. The reinforcement element 23 is held in its position by the foam 50 or in another way (e.g. screws).

The plastic hollow profile 111 of the first embodiment has a hollow chamber that is continuous from the interior side to the weather side. This hollow chamber is foam-filled with the foam 50 for reasons of heat insulation and strength enhancement. Depending on the requirements, the plastic hollow profile can have one or more hollow chambers that are foam-filled entirely, partially or not at all. The density of the foam that is used can be varied depending on the requirements.

On the left hand side of FIG. 1, a plastic hollow profile 112 is shown that is a part of a frame profile. Aluminum hollow profiles 24, 25 are connected in a longitudinally-fixed manner to the plastic hollow profile 112 via roll-in protrusions 124 a, 125a by rolling-in in the same manner as in the plastic hollow profile 111. The plastic hollow profile 112 also has a hollow chamber that is continuous from the weather side to the interior side, which hollow chamber is foam-filled with a foam 50. In a comparable manner, the aluminum profiles 24, 25 have hollow chambers 24a, 25a surrounded by outer walls that are rectangular in cross-section. In the hollow profile 112 too, the roll-in protrusions 124a together with a corresponding outer wall 124b of the plastic hollow profile 112 form a receptacle 124, into which the hollow chamber 24a of the aluminum hollow profile is inserted. The aluminum hollow profile 24 is again in contact only with the heads 124aa of the roll-in protrusions 124a of the plastic hollow profile 112 and is otherwise surrounded by an insulating air layer. The same can be said about the longitudinally-fixed attachment of the aluminum hollow profile 25 by rolling-in, wherein the receptacle 125 is bounded by the roll-in protrusions 125a and the outer wall 125b. The plastic hollow profile 112 reinforced with the aluminum profile 25 has an undercut recess 133 for accommodation of locking and fitting elements. Different from the undercut recess 131 of the plastic hollow profile 111, this recess is not exclusively formed by the plastic hollow profile, but rather by the combination of the plastic hollow profile 112 with the aluminum hollow profile 25. This means the undercut recess is partly formed by components (outer wall, protrusions) 133b, 133a of the plastic hollow profile and partly by components (protrusion 25b) of the aluminum hollow profile 25. In the embodiment shown in FIG. 1, no reinforcement element for the secure attachment of the fitting and locking elements is provided. It can, however, be made in various ways, as is described with reference to FIGS. 2 and 3.

As can be derived from the description of the first embodiment, the plastic hollow profile makes possible a significant increase of the proportion of the insulating zone out of the total construction depth for comparable constructional depths. This is made possible, for example, by the fact that the roll-in protrusions on the respective outer side are the farthest protruding sections/parts of the plastic hollow profile.

If the reinforcement element is formed with a hollow profile, the hollow profile is to be arranged in a way that it is located substantially (at least more than 50%) within the constructional depth in the transverse direction x, preferably to the largest extent, i.e. 80% or more, more preferably 90% or more, even more preferably completely except for the outer wall, relative to the protruding of the roll-in protrusions, preferably between the roll-in protrusions.

The reinforcement elements and the hollow chambers 21a, 22a, 24a, 25a, respectively, of the aluminum hollow profiles can preferably be used as the receptacle portion for accommodating a corner connector.

The aluminum hollow profiles are preferably manufactured by aluminum extrusion, so that the cross-section of the aluminum hollow profiles is identical over the entire length in the longitudinal direction. In this case, the hollow profile and thus also the receptacle portion for the accommodation of a corner connector, is located between the roll-in protrusions in the above described manner.

The reinforcement elements can also be formed as partially-open profiles. In this context, partially-open profile means a profile that has a cross-sectional shape (e.g. a U-shape or the like) in its cross-section (x-y) perpendicular to its longitudinal direction z, which partially, but not entirely, surrounds a space. A further example of a partially-open profile is a rectangular profile that is not completely closed on one side of the rectangle, and the like.

The plastic hollow profiles 111, 112 possess a positionally-precise calibration of the roll-in protrusions relative to the outer geometry of the plastic hollow profiles, so that the aluminum hollow profiles and the receptacle portions for the corner connectors, respectively, can be positioned by means of the longitudinally-fixed rolling-in in a positionally-precise manner relative to the outer geometry. Consequently, a positionally-precise connection of the reinforced plastic hollow profiles via corner connectors or via other corner connections, such as e.g., welding, is possible and the time and effort of the post-processing work of such corner connections is minimized.

In the following, a method for manufacturing the plastic hollow profiles shown in FIG. 1 and FIG. 6 will be described. Methods and devices for manufacturing a hollow chamber profile, with which individual components or the entire hollow chamber profile can be calibrated in a positionally-precise manner, are described in the WO 96/30188 A1 and the DE 199 21 458 A1 respectively. The plastic hollow profiles 111, 112 of the first embodiment are manufactured using suitable methods, wherein materials are chosen that are color-, light- and/or weather-proof, depending on the requirements. In this manufacturing, the profiles are extruded and preferably at least the outer surfaces and the roll-in protrusions are calibrated in a positionally-precise manner. Suitable materials are rigid-PVC, PA, PET, PPT, PA/PPE, ASA, PA66 and others (each with or without reinforcement materials).

The reinforcement parts are preferably manufactured by aluminum extrusion. The protrusions of the reinforcement parts, which have to be rolled-in, are preferably prepared by knurling.

Thermosetting plastics, such as PU, having an appropriate density can be used as foams for foam-filling the plastic hollow profiles. Preferably, foams having a low density (0.01 to 0.3 kg/l) are used. If foam having a high density is to be used, foams with 0.3 to 0.6 kg/l are preferably used.

With the above described embodiment, arbitrary undercuts are possible at arbitrary locations of the profile. The surface treatment of outer and inner covers made of aluminum or other materials can be carried out independent of a foaming process, which is advantageous, in case the foam does not tolerate annealing temperatures. In addition to this advantage, the described embodiment provides a system with excellent mechanical properties, wherein the reinforcement profiles can be used for the corner connection using corner connectors and, at the same time, the necessary post-processing work is minimized. The embodiment also enables the use of foams of different density and the resulting optimization of heat conducting properties.

The described embodiment enables proportions of the insulating zone formed from plastic of 95% or more, in any case of 80% or more of the total construction depth, with excellent mechanical properties that are achieved due to the longitudinally-fixed rolling-in of the aluminum hollow profiles.

A second embodiment is described with reference to FIG. 2. In the second embodiment, the window wing profile is identical to the window wing profile of the first embodiment and therefore the description is not repeated.

The frame profile includes a plastic hollow profile 113 whose design corresponds to the plastic hollow profile 112 of the first embodiment, except for the formation of the recess 125 and the recess 134; a reinforcement element 27 is inserted in the recess 134.

As can be clearly seen in FIG. 2, the outer wall 125b does not extend to the outer wall 133b, but rather transitions into the wall 125c shortly before the outer wall 133b; the wall 125c forms an outer wall for bounding the receptacle 125. In this way, the undercut recess 134 is formed, which is located at the inner side of the outer wall 133b opposite to the undercut recess 133. A reinforcement element 27 is inserted into this undercut recess 134, which reinforcement element 27 serves to securely attach fitting and locking elements that are guided in the undercut recess 133, analogous to the reinforcement 23.

The remaining design of the plastic hollow profile 113 corresponds to the design of the plastic hollow profile 112 of the first embodiment, and therefore, the description is not repeated.

A third embodiment is described with reference to FIG. 3. The window wing profile of the third embodiment corresponds to the window wing profile of the first and second embodiments, and therefore, the description is not repeated here.

The frame profile of the third embodiment differs from the frame profiles of the first and second embodiments in the formation of the receptacle 126 and of the aluminum hollow profile 26.

As can be clearly seen in FIG. 3, the aluminum hollow profile 26 is rolled-in at the interior side of the frame profile in a known manner. The shape of the aluminum hollow profile 26 corresponds to the shape of the aluminum hollow profile 25, except for the protrusion 26c that protrudes on the interior side of the aluminum hollow profile 26 in the width direction y and that forms a reinforcement element that extends in the transverse direction x and the longitudinal direction z. A receptacle 126 is bounded by roll-in protrusions 126a, the tips 126aa of which serve as roll-in protrusions for the protrusions 26ba of the aluminum profile 26. For accommodating the reinforcement element 26c, the receptacle 126 is provided with a recess extending in the transverse direction x and the longitudinal direction z, which is bounded by a wall 126c, so that the reinforcement element 26c extends, like the reinforcement element 27, on the inner side of the outer wall 133b opposed to the undercut recess 133. Therefore, the reinforcement element 26c can fulfil essentially the same function as the reinforcement element 27.

A fourth embodiment is described with reference to FIG. 4.

The fourth embodiment differs from the second embodiment in that the integral plastic hollow profiles 111 and 113 are replaced by multi-part plastic hollow profiles 115 and 116. The remaining design corresponds to the design of the second embodiment. Unlike the plastic hollow profile 111, the plastic hollow profile 115 of the window wing profile is not integrally formed, but rather is formed of a plurality of parts. The outer walls 115a are connected via an inner element 115b that forms inner bars (e.g. via not-illustrated plug-in, clip-on or other connections). The use of the inner bars 115b increases the mechanical rigidity and results in the formation of a plurality of hollow chambers. These hollow chambers can optionally be entirely or partially foam-filled.

The plastic hollow profile 116, which replaces the plastic hollow profile 113 of the second embodiment, is formed in a similar way. This means the outer walls 116a are connected via an inner part 116b that forms inner bars, wherein a plurality of hollow chambers is formed.

A fifth embodiment will be described with reference to FIG. 5.

The fifth embodiment differs from the third embodiment in the design of the plastic hollow profiles 115 and 117. The window wing profile of the fifth embodiment corresponds to the window wing profile of the fourth embodiment, and therefore, the description is not repeated here.

As compared to the frame profile of the fourth embodiment, the frame profile of the fifth embodiment has an aluminum hollow profile 26 instead of the aluminum profile 25 that is provided in the third embodiment. The plastic hollow profile 117 of the fifth embodiment merely differs from the plastic hollow profile 116 of the fourth embodiment in that no undercut recess for the accommodation of the reinforcement element 27 is formed. Instead, the reinforcement element 26c, which is an integral component of the aluminum hollow profile 26, is located on the inner side of the outer wall 133b that forms the back wall of the undercut recess 133.

The remaining design of the fifth embodiment corresponds to the design of the fourth embodiment and is therefore omitted.

The manufacturing method described for the first embodiment and the properties and advantages described for the first embodiment are also applicable or are maintained in the second to fifth embodiments. The features of the first to fifth embodiments can be freely combined according to the requirements.

It is explicitly stated that all features disclosed in the description and/or the claims, should be regarded as separate and independent of each other for the purpose of original disclosure as well as for the purpose of restricting the claimed invention, independent of the combination of features in the embodiments and/or the claims. It is explicitly stated that all indications of ranges or of groups of units disclose every possible intermediate value or sub-group of units for the purpose of original disclosure as well as for the purpose of restricting the claimed invention, especially also as a limit of a range indication.

1-20. (canceled)

21. A plastic profile for window, door and facade elements, comprising:
a plastic profile body extending in a longitudinal direction (z) and having at least one outer side located outside in a transverse direction (x) perpendicular to the longitudinal direction (z) as viewed in a cross-section (x-y) perpendicular to the longitudinal direction (z), the at least one outer side being configured such that a reinforcement element is connectable with the plastic profile body by a rolled-in connection, the reinforcement element having at least one of a hollow profile and a receptacle portion configured to accommodate a corner connector, and
two roll-in protrusions disposed on the at least one outer side such that at least one of the hollow profile and the receptacle portion of the reinforcement element is substantially disposed between the two roll-in protrusions when the reinforcement element is connected to the plastic profile body.

22. A plastic profile according to claim 21, wherein the plastic profile body has two outer sides opposite of each other in the transverse direction (x), the two outer sides being configured such that respective reinforcement elements are connectable with the plastic profile body by a rolled-in connection, each reinforcement element having at least one of a hollow profile and a receptacle portion configured to accommodate a corner connector, and wherein each of the two respective outer sides of the plastic profile body comprises two roll-in protrusions configured such that at least one of the hollow profile and the receptacle portion of the reinforcement element is substantially disposed between the two roll-in protrusions when the reinforcement element is connected to the plastic profile body.

23. A plastic profile according to claim 21, wherein the two roll-in protrusions are provided such that the two roll-in protrusions are the farthest protruding portions of the plastic profile body on the at least one outer side in the transverse direction (x).

24. A plastic profile for window, door and facade elements, comprising:
a plastic profile body extending in a longitudinal direction (z) and having at least one outer side located outside in a transverse direction (x) perpendicular to the longitudinal direction as viewed in a cross-section (x-y) perpendicular to the longitudinal direction (z), the at least one outer side being configured such that a first reinforcement element is connectable with the plastic profile body by a rolled-in connection, the first reinforcement element having at least one of a hollow profile, a partially-open profile and a receptacle portion configured to accommodate a corner connector, and
two roll-in protrusions provided on the at least one outer side such that the roll-in protrusions are the farthest protruding portions of the plastic profile body on the at least one outer side in the transverse direction (x), wherein at least one of the hollow profile, the partially-open profile and the receptacle portion of the first reinforcement element is substantially disposed between the two roll-in protrusions in the transverse direction (x) when the first reinforcement element is connected to the plastic profile body.

25. A plastic profile according to claim 24, wherein the plastic profile body has two outer sides opposite of each other in the transverse direction (x), the two outer sides being configured such that respective first reinforcement elements are connectable with the plastic profile body by a rolled-in connection, each first reinforcement element having at least one of a hollow profile, a partially-open profile and a receptacle portion configured to accommodate a corner connector, and wherein two roll-in protrusions are disposed on each of the respective outer sides such that the roll-in protrusions are the farthest protruding portions of the plastic profile body on each respective outer side in the transverse direction (x), wherein at least one of the hollow profile, the partially-open profile and the receptacle portion of the first reinforcement element is substantially disposed between the two roll-in protrusions in the transverse direction (x) when the first reinforcement element is connected to the plastic profile body.

26. A plastic profile according to claim 25, wherein the transverse direction (x) extends from a weather side of the plastic profile to an interior side of the plastic profile when the plastic profile is installed in a window, door, or facade element.

27. A reinforced plastic profile for window, door and facade elements, comprising:
a plastic profile body extending in a longitudinal direction (z) and having at least one outer side located outside in a transverse direction (x) perpendicular to the longitudinal direction as viewed in a cross-section (x-y) perpendicular to the longitudinal direction (z),
at least one reinforcement element having one of a hollow profile, a partially-open profile and a receptacle portion configured to accommodate a corner connector, the at least one first reinforcement element is connected with the plastic profile body in a longitudinally-fixed manner via two roll-in protrusions provided on the at least one outer side such that at least one of:
(i) at least one of the hollow profile and the receptacle portion of the at least one reinforcement element is disposed substantially between the two roll-in protrusions in the transverse direction (x), and
(ii) the two roll-in protrusions disposed on the at least one outer side of the plastic profile part are the farthest outwardly protruding portions of the plastic profile body in the transverse direction (x) and, in the rolled-in state, at least one of the hollow profile, the partially-open profile and the receptacle portion of the at least one reinforcement element is disposed substantially between the two roll-in protrusions in the transverse direction (x).

28. A reinforced plastic profile according to claim 27, wherein the plastic profile body is connected to the first reinforcement element via the roll-in protrusions in a longitudinally-fixed manner by the rolled-in connection.

29. A reinforced plastic profile according to claim 28, wherein an insulating zone is defined in the plastic profile body and has a length in the transverse direction (x) that is at least 80% of the total length of the reinforced plastic profile in the transverse direction (x).

30. A reinforced plastic-profile according to claim 29, wherein the insulating zone has a length in the transverse direction (x) that is at least 90% of the total length of the reinforced plastic profile in the transverse direction (x).

31. A reinforced plastic profile according to claim 30, wherein the transverse direction (x) extends from a weather side of the plastic profile to an interior side of the plastic profile when the plastic profile is installed in a window, door, or facade element.

32. A reinforced plastic profile according to claim 31, wherein the at least one reinforcement element has a closed hollow profile and two roll-in protrusions extending from opposite sides of the closed hollow profile in a width direction (y) that is perpendicular to the longitudinal direction (z) and the transverse direction (x).

33. A reinforced plastic profile according to claim 32, wherein the two roll-in protrusions of the reinforcement element are connected to the two roll-in protrusions of the plastic profile body, respectively, by a plastic deformation of the two roll-in protrusions of the reinforcement elements around the two roll-in protrusions of the plastic profile body, such that reinforcement element contacts the plastic profile body substantially only at the protrusion contact points.

34. A reinforced plastic profile according to claim 33, wherein the reinforcement profile comprises aluminum and has a closed rectangular shape in the cross-section (x-y) perpendicular to the longitudinal direction (z).

35. A reinforced plastic profile according to claim 34, wherein an inward-facing surface of the reinforcement profile is spaced from the plastic profile body with an air layer in between.

36. A reinforced plastic profile according to claim 27, wherein the at least one reinforcement element has a closed hollow profile and two roll-in protrusions extending from opposite sides of the closed hollow profile in a width direction (y) that is perpendicular to the longitudinal direction (z) and the transverse direction (x).

37. A reinforced plastic profile according to claim 27, wherein the two roll-in protrusions of the reinforcement element are connected to the two roll-in protrusions of the plastic profile body, respectively, by a plastic deformation of the two roll-in protrusions of the reinforcement elements around the two roll-in protrusions of the plastic profile body, such that reinforcement element contacts the plastic profile body substantially only at the protrusion contact points.

38. A reinforced plastic profile according to claim 27, wherein the reinforcement profile comprises aluminum and has a closed rectangular shape in the cross-section (x-y) perpendicular to the longitudinal direction (z).

39. A reinforced plastic profile according to claim 27, wherein an inward-facing surface of the reinforcement profile is spaced from the plastic profile body with an air layer in between.

40. An apparatus comprising:
a structural element selected from a window pane, door leaf or facade, and
a reinforced plastic profile according to claim 27 connected to the structural element.
